(19) United States
(12) Patent Application Publication
(10) Pub. No.: US 2016/0075271 A1
(43) Pub. Date: Mar. 17, 2016

(54) System for Converting Standard Truck to Water Tanker

(71) Applicant: EZ PACK WATER LTD., Savion (IL)

(72) Inventors: Alex Harel, Savion (IL); Shalom Green, Haifa (IL)

(73) Assignee: EZ PACK WATER LTD, Savion (IL)

(21) Appl. No.: 14/783,466

(22) PCT Filed: Mar. 17, 2014
(86) PCT No.: PCT/IL2014/050295

§ 371 Date: Oct. 9, 2015

(30) Foreign Application Priority Data
Apr. 10, 2013 (IL) 225681

(51) Int. Cl. B60P 3/42

(52) U.S. Cl. CPC B60P 3/426

(57) ABSTRACT

A portable and modular system for converting a standard truck easily to a water tanker which is aimed to be placed and structured on a truck platform comprises: several frames, several connecting rods, several carrying sheets and one or more of inflatable flexible water bags. The frames are designed in a rectangular shape wherein two of them are ending frames and the others are middle frames. Each of the frames includes connecting means. The connecting rods are aimed to connect and stabilize the frames when they are placed on a truck platform. Each of the connecting rods includes connecting means which are corresponded with the connecting means of the frames. Each of the carrying sheets is designed in a rectangular shape and its edges end with sleeves.

### TECHNICAL FIELD

The present invention relates to a system for converting easily a standard truck to a water tanker which includes a couple of inflatable flexible water bags.

### BACKGROUND ART

A water tanker is a truck that has a huge water tank on its platform. Many organizations have truck fleet which includes several water tankers, for example armies and emergency forces, that use water tankers for mobilizing and supplying fresh drinking water for groups of people while they are in the countryside. Usage of conventional water tankers involves several problems. First, when there is no need to mobilize water it is impossible in practice to use the water tanker vehicle for mobilizing other kind of transports because the water tank cannot be removed and put back on the truck platform. Second, the water tank is usually a rigid metal or plastic material and the usage of such types of rigid tanks involves problems of chlorinating and cleaning the tank which are both costly and time consuming processes. The present invention aims to provide an effective and efficient solution for these problems.

### LIST OF DRAWINGS

The intention of the drawings attached to the application is not to limit the scope of the invention and its application. The drawings are intended only to illustrate the invention and they constitute only one of its many possible implementations.

FIG. 1 describes ending frame (1), connecting means (11) and connecting ends (2).

FIG. 2 describes the middle frame (1) and the connecting means (11).

FIG. 3 describes connecting rods (3) and couple of the middle frames (1).

FIG. 4 describes the carrying sheets (4) with the sleeves (41).

FIGS. 5 and 6 describe the System on the truck platform (100).

FIGS. 7-9 describe the frames (1) and the rods (3) after they were placed on the truck platform (100).

FIG. 10 describes the connection of the rod (3) to the frame (1).

FIGS. 11 and 12 describe the System after it was placed on the truck platform (100) and fastened by the fastening straps (6).

FIG. 13 describes the connection of the fastening straps (6) to the frame (1).

### THE INVENTION

The main object of the present invention is to provide a portable and modular system for converting a standard truck easily to a water tanker, and vice versa. It is also an object of the present invention to provide the system wherein the weight of each part of it is not relatively heavy and one or two persons can lift, place and build it on the truck platform. In addition, it is also an object of the present invention to provide the system wherein it includes a couple of inflatable flexible water bags.

The system subject matter of the present invention (hereinafter “the System”) comprises several frames (1), several connecting rods (3), several carrying sheets (4) and couple of inflatable flexible water bags (5).

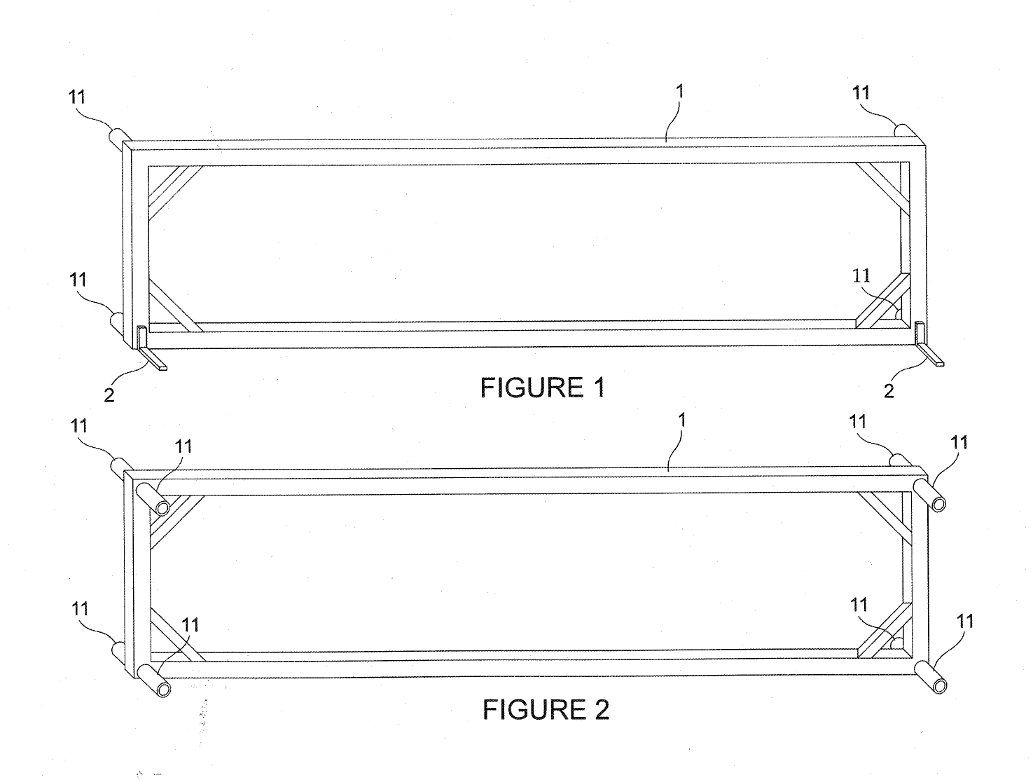

The frame (1) is designed in general in a rectangular shape as described for example in FIGS. 1 and 2 and it is preferably made of metal rods in diameter size of about 50 mm, or other size as required by the designated load. It is preferably that the height of the frame (1) will be around 600 mm and its width is around 2400 mm. It goes without saying that these sizes should be in accordance with the truck platform on which the System is aimed to be placed.

The frames (1) should be put on the truck platform (100) as described for example in FIG. 6 and they should be connected one to each other by the connecting rods (3). From the above description it is understood that the number of the frame (1) units in each implementation of the System depends on the length of the truck platform (100). It is also understood that two frames (1) are aimed to be located in the both ends of the system (hereinafter “ending frame (1)”) and all the other frames (1) are aimed to be located in the middle (hereinafter “the middle frame (1)”). Each corner of the both sides of the middle frame (1) has a connecting means (11) that is aimed to connect the frames (1) together on the truck platform (100). Also there is a connecting means (11) in each corner of one side of the ending frame (1) and on the other side there is a possibility to add a connecting ends (2) for connecting the frame (1) to standard lock system such as twist lock of standard trucks.

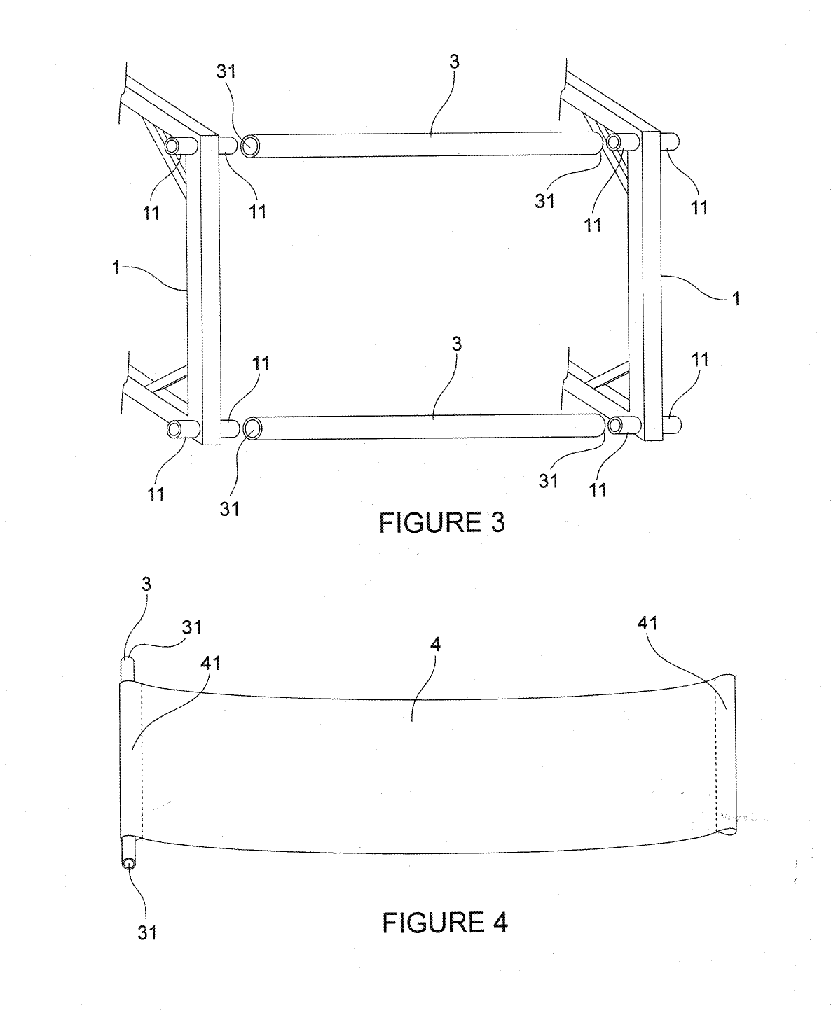

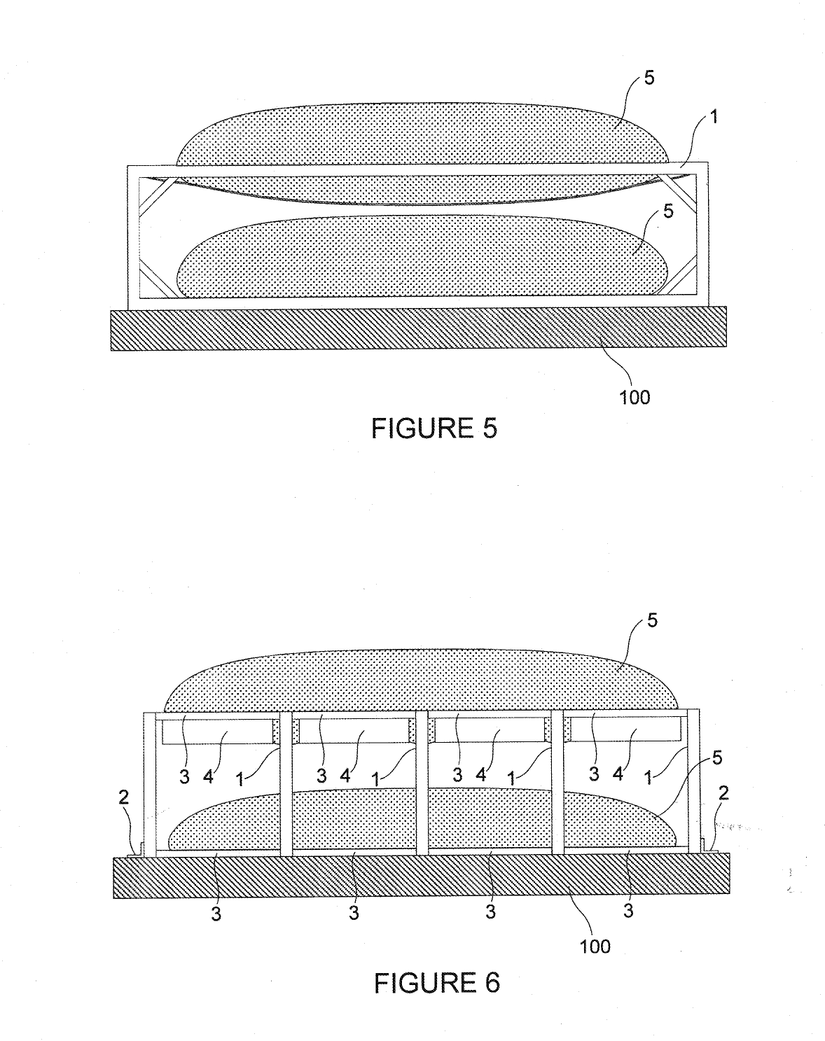

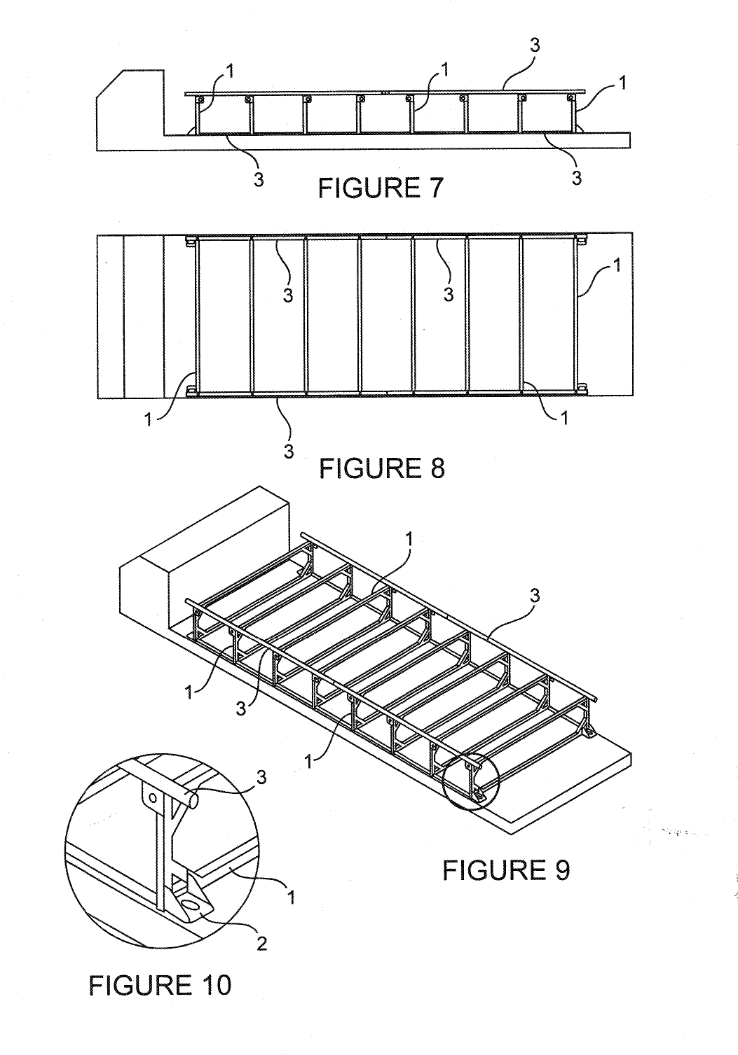

The connecting rods (3) are aimed to connect and stabilized the frames (1) when they are located in a line in a perpendicular position on the truck platform (100). The connecting rods (3) include connecting means (31) which are corresponded with the connecting means (11) of the frames (1). In FIGS. 1-6 the connecting means 11 is designed as a short rod that aimed to be corresponded to the connecting means 31 which designed as a horizontal hole in the rod (3). In FIGS. 7-13 the connecting means 11 of the frames (1) are designed as a hole (11) that aimed to correspond to the connecting means 31 which designed as a pin that protrudes from the rod (3). However, these ways of connection described as an example only. In addition, it is possible that the length of the rods (3) will be corresponded to the length between the frames (1) when they are placed on the truck platform (100) or longer. In the first case each rod (3) connects a frame (1) with the following frame (1) and in case of using longer rods (3) each rod (3) can connect several frames (1) together.

The carrying sheet (4) is designed generally in a rectangular shape and it is preferably that it will be made of a strong material such as a tarpaulin. The length of the carrying sheets (4) should be fitted to the width of the frames (1) and their width should be fitted to the length of the connecting rods (3). The width edges of the carrying sheets (4) end with sleeves (41) in a way that it is possible to insert the connecting rod (3) into this sleeve (41).

The inflatable flexible water bag (5) (hereinafter “the water bag”) can be made of two layers: internal flexible and inflatable layer that made of materials that meet the standards for usage with fresh drinking water and external layer made of flexible inflatable strong and tough materials to avoid incision and cutting the bag, or from one layer if the water is not for drinking. The water bags (5) include water inlet ports.

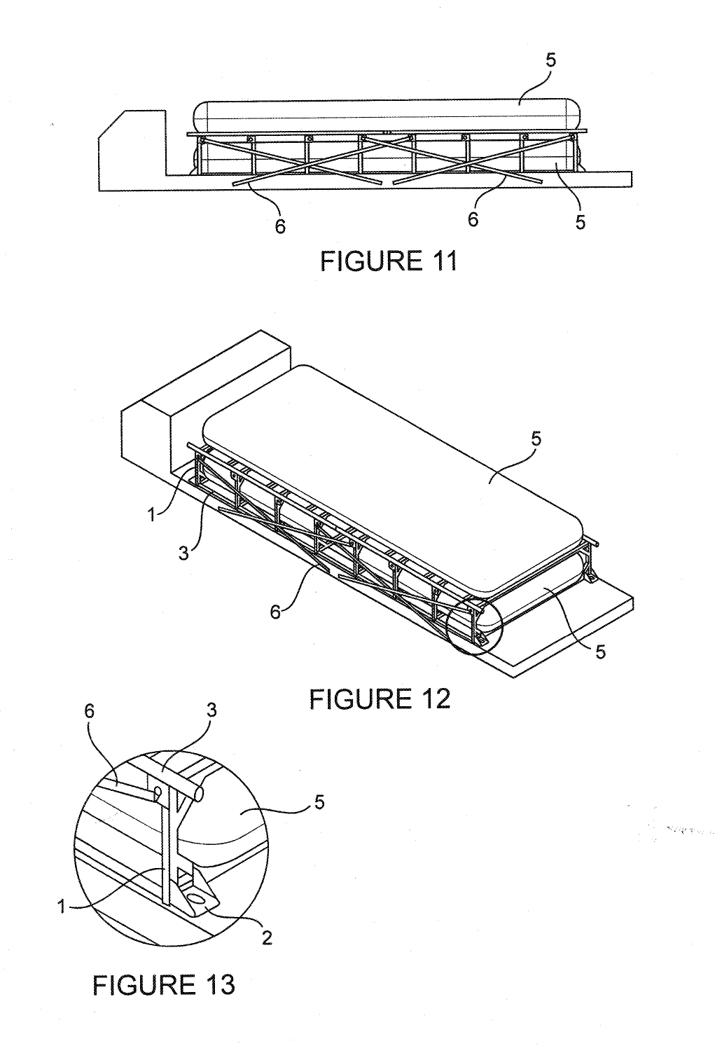

The System may also include several fastening straps (6) that are aimed to fasten the frames (1) to the truck platform (100). FIGS. 11 and 12 describe the System wherein the frames (1) are fastened by the fastening straps (6). FIG. 13 describes one option for example of connecting a fastening strap (6) to the frame (1).

The components of the System can be stored everywhere. When there is a necessity to transport fresh water it is possible to convert any standard truck to a water tanker simply by structuring the System on the truck platform (100). The truck platform (100) can be the standard platform of the truck itself or of a trailer. The amount and the size of the System's components depend on the size of the truck platform (100).

Structure of the System: The System in the following example, and also as described in FIGS. 7, 8, 9, 11 and 12, includes two end frames (1), six middle frames (1), fourteen short connecting rods (3), four long rods (3), seven carrying sheets (4) and eight fastening straps (6). (a) Locating eight frames (1) on the truck platform (100) when the first and the last frames (1) are ending frames and the other six are middle frames. (b) Securing the ending frames (1) to the truck platform (100). (c) Connect the lower parts of the frames (1) by using fourteen short connecting rods (3). (d) Insert four long connecting rods (3) into the sleeves (41) of seven carrying sheets (4). (e) Connect the upper parts of the frames (1) by using those four long connecting rods (3) which have already been inserted in the sleeves (41). (f) Fasten the frames (1) by using the fastening straps (6). (g) Put one water bag on the bottom ribs of the frames (1) and another one on the carrying sheets (4) as described for example in FIGS. 11 and 12. The n, it is possible to fill water in the water bags (5) and transport the water to the destination. Each part of the System may not be more than 25 kg and by that two persons can structure and re-structure the System on a standard truck platform (100).

What is claimed is:

1. A portable and modular system for converting a standard truck easily to a water tanker which is aimed to be placed and structured on a truck platform comprises: several frames, several connecting rods, several carrying sheets and one or more of inflatable flexible water bags;
wherein the said frames are designed in general in a rectangular shape; wherein two of the said frames are aimed to be ending frames and the others are aimed to be middle frames; wherein each of the said frames includes connecting means;
wherein the said connecting rods are aimed to connect and stabilize the frames when they are placed on a truck platform; wherein each of the said connecting rods includes connecting means which are corresponded with the said connecting means of the said frames;
wherein each of the said carrying sheets is designed generally in a rectangular shape and its edges end with sleeves.
